(19) United States
(12) Patent Application Publication
(10) Pub. No.: US 2003/0129119 A1
(43) Pub. Date: Jul. 10, 2003

(54) Nanocarbon materials and process for producing the same

(76) Inventors: Hsin-Tien Chiu, Taipei City (TW); Chi-Young Lee, Hsin-Chu Hsien (TW); Chih-Wei Peng, Hsin-Chu Hsien (TW); Ming-Yu Yen, Tai-Tung City (TW); Yu-Hsu Chang, Tao-Yuan City (TW)

Correspondence Address: MARSHALL, GERSTEIN & BORUN, 6300 SEARS TOWER, 233 SOUTH WACKER, CHICAGO, IL, 60606-6357, US

(21) Appl. No.: 10/155,436

(22) Filed: May 24, 2002

(30) Foreign Application Priority Data
Jan. 7, 2002 (TW) 091100363

(51) Int. Cl. C01B 31/02

(52) U.S. Cl. 423/445 R

(57) ABSTRACT

In a process for producing nanocarbon materials, a metal reducing agent and a carbon source are subjected to a chemical reduction reaction under an atmosphere which will not interfere with the reaction and at a temperature preferably lower than 1000° C., such that a nanocarbon material having a graphite-like structure is formed therefrom. Optionally, an additive, e.g. a fullerene compound, or a porous substrate such as zeolite powder, may be used during the production of the nanocarbon material.

### BACKGROUND OF THE INVENTION

1) Field of the Invention

This invention relates to nanocarbon materials and processes for producing the same. Specifically, according to this invention, a metal reducing agent and a carbon source are subjected to a chemical reduction reaction under an atmosphere which will not interfere with the reaction and at a temperature preferably lower than 1000° C., such that a nanocarbon material having a graphite-like structure is formed therefrom.

2) Description of the Related Art

Recently, researchers in both the field of Chemistry and the field of Materials Science have expressed interest in the development of nanocarbon materials, and extensive investigations directed thereto are in progress. Nanocarbon materials are contemplated to have innumerable industrial values due to their potential applications in the manufacture of products including display devices, electronic components, battery cells, support materials for catalysts, etc.

In contrast to the elemental carbon atoms of diamonds which exist in the sp³-hybridized configuration, the elemental carbon atoms of various nanocarbon materials, including caged carbon balls (i.e. the so-called Fullerene compounds), carbon nanotubes (CNT), carbon onions, nano graphite and carbon nanorods, exist in the sp²-hybridized configuration.

In the prior art, except for the variation of the carbon sources in use, the conventional processes for producing artificial carbon materials of the above-mentioned types are essentially conducted under vigorous reaction conditions involving high temperatures and/or high pressures. For example, in order to produce graphite pro ducts having excellent crystallization, the conventional processes normally should be conducted at an operating temperature of at least 2000° C. or higher, which, however, renders the desired nano-size graphite products difficult to produce.

The conventional processes for producing nanocarbon materials primarily include the arc discharge method, the chemical vapor deposition method, the laser ablation method and so forth, amongst which the arc discharge method has been used in the production of carbon nanotubes for years. For example, U.S. Pat. No. 5,482,601 disclosed a process for producing carbon nanotubes, according to which two electrodes made of amorphous carbon or graphite are positioned within a reaction vessel and spaced apart by about 1 mm, followed by evacuating the reaction vessel to a pressure of about 10⁻⁷ torr. Thereafter, an inert gas, such as helium gas, nitrogen gas or argon gas, is introduced into the reaction vessel to provide a pressure of about 50-500 torr, and a high direct current (DC) potential is applied between the electrodes to cause an arc discharge to occur. The resultant high energy plasma may impinge the anode rod to generate C⁺ cations, which, in turn, will be adsorbed and gradually accumulated onto the cathode rod, such that the desired carbon nanotubes are formed therefrom. Since the anode rod is consumed as the arc discharge proceeds, in order to satisfy the requirement for the production of plasma, it is necessary to displace the two electrode rods to maintain a constant gap therebetween. Therefore, at least one of the two electrode rods, normally the cathode rod, should be displaced, such that a new surface on the cathode rod will continuously be exposed to allow the deposition of nanocarbon particles thereon. In addition to U.S. Pat. No. 5,482,601, the arc discharge method has been disclosed in, e.g. U.S. Pat. No. 5,227,038, U.S. Pat. No. 5,091,025 and U.S. Pat. No. 5,830,326.

However, the arc discharge method is costly in manufacture as it requires the application of high energy. Moreover, the nanocarbon materials produced therefrom are of poor purity and properties, and usually contain therein a rather high content of amorphous carbon, which normally can be eliminated by conducting a purification treatment using an acid. However, such a purification treatment concomitantly results in the undesired destruction of the structure of nanocarbon materials treated thereby. Besides, while it is common in the manufacturing procedures of single-wall carbon nanotubes (SWNTs) to use a catalyst containing a transition metal or an oxide thereof, or a lanthanide, etc., to facilitate the adsorption of coupled carbon atoms, this will undesirably bring about the problem that the catalyst employed therein is difficult to remove and/or will interfere with the applications of the nanocarbon materials produced therefrom. For these reasons, the industrial values of the arc discharge method are vastly diminished.

Another known technique widely employed by manufacturers in the industry is the chemical vapor deposition (CVD) method, in which the carbon nanotubes are synthesized primarily from the thermal decomposition of small hydrocarbon precursors. However, this method is costly due to lack of suitable precursor molecules for use. In addition, it is necessary for this method to use a microwave or a biasing electric field to improve the crystallization property And the crystal growth orientation of the resultant products. Although products produced by this method may be of a higher purity and with a lower content of amorphous carbon, the yield thereof is not high enough, thus requiring the addition of a metal catalyst in the synthesis procedures to enhance the adsorption of the deposited carbon atoms. However, the use of a metal catalyst during the production of nanocarbon materials would result in the formation of undesired metal carbide particles, which are difficult to remove even, by use of an acid or a base and, thus, cause the problem of purification.

The laser ablation method catalytically synthesizes nanocarbon materials by irradiating graphite or a carbon-containing molecule such as perchloroacenaphthylene (Cl₂Cl₈) with a high energy laser beam in the presence of a transition metal catalyst. This method is developed primarily for the production of nanocarbon materials at the end regions of specific elements and, thus, cannot produce products of a high yield.

The above three conventional methods are energy-consuming and normally involve the use of complex and expensive equipments for practice. Other processes, such as the flame method and the hydrothermal method, also have the above-mentioned problems, including difficulty in isolation and purification, production of products of a low yield, and the use of a metal catalyst.

In addition to the aforementioned patents, there are some other methods disclosed in published patent documents, see, e.g. U.S. Pat. No. 4,014,980, U.S. Pat. No. 6,063,243 and U.S. Pat. No. 6,221,330, and in relevant scientific articles, such as Z. F. Ren et al., Science (1990), 282:1105-1107; Shoushan Fan et al., Science (1999), 283:512-514; Zujin Shi et al., Carbon (1999), 37:1449-1453; F. Kokai, et al., The Journal of Phisical Chemistry B (2000), 104:6777; Yury Gogotsi et al., J. Mater. Res. (2000), 15:2591-2594; X. H. Chen et al., J. Mater. Res. (2000), 15:2591-2594; X. Chen et al., Chemical Physical Letters (2001), 336:201-204; and Houjin Huang et al., Chemical Physical Letters (2001), 343:7-14. All of the patents and literature reference cited above are hereby incorporated by reference in their entirety.

Summing up the aforesaid, the existing processes for producing nanocarbon materials share the following common drawbacks: high-energy consumption in manufacture, high cost of complex equipments for practice, production of products of poor purity and properties, and difficulty in purifying products produced thereby. Therefore, in view of a broad spectrum of applications of nanocarbon materials in the fields of Electronics, Photoelectronics, Energy and Chemical Engineering, there exists a great need for both chemists and manufacturers in the industry to develop a new process to produce nanocarbon materials, which is energy-saving and cost-efficient and which can be practiced using simple equipments, and from which products of higher yields can be easily purified.

### SUMMARY OF THE INVENTION

In view of the drawbacks of the existing processes mentioned above, after conducting a number of experiments, the applicants have successfully developed a new process for the production of nanocarbon materials, in which a metal reducing agent and a carbon source are subjected to a chemical reduction reaction under an atmosphere which will not interfere with the reaction and at a temperature preferably lower than 1000° C., such that a nanocarbon material having a graphite-like structure is formed therefrom.

Accordingly, the present invention provides a process for producing nanocarbon materials, which comprises the step of subjecting a metal reducing agent and a carbon source to a chemical reduction reaction under an atmosphere which will not interfere with the reaction to yield the nanocarbon material.

In a preferred embodiment of the present invention, the atmosphere which will not interfere with the reaction is provided by placing the metal reducing agent and the carbon source under an atmosphere of an inert gas. Preferably, the inert gas is selected from the group consisting of nitrogen gas, helium gas, argon gas, neon gas, krypton gas, xeon gas, and combinations thereof. More preferably, the inert gas is argon gas or nitrogen gas.

In another preferred embodiment of the present invention, the atmosphere which will not interfere with the reaction is provided by placing the metal reducing agent and the carbon source under an atmosphere of a reduced pressure. Preferably, the atmosphere of a reduced pressure is provided by placing the metal reducing agent and the carbon source into a reaction container under ambient temperature and pressure, followed by evacuating and sealing the reaction container.

Preferably, the process of the present invention may further include a heating treatment of the metal reducing agent and the carbon source. In a preferred embodiment, the metal reducing agent and the carbon source are subjected to a heat treatment at a temperature ranging from 50 to 500° C. In another preferred embodiment, the metal reducing agent and the carbon source are subjected to a heat treatment at a temperature ranging from 100 to 400° C. In a further preferred embodiment, the metal reducing agent and the carbon source are subjected to a heat treatment at a temperature ranging from 100 to 200° C. In yet another preferred embodiment, the metal reducing agent and the carbon source are subjected to a heat treatment at a temperature ranging from 300 to 500° C.

Preferably, the process of the present invention may further comprise a step of purifying the resultant nanocarbon material. In a preferred embodiment, the purifying step is conducted by washing and refluxing the nanocarbon material with 100° C. deionized water, followed by drying.

Preferably, the metal reducing agent suitable for use in the process of the present invention includes a metal element selected from a group consisting of group IA metals, group IIA metals, Sn, Ga, In, Pb, Al, Zn, Cu, and combinations thereof. In a preferred embodiment, the metal reducing agent employed in the process of the present invention is Na or Sn.

Preferably, the carbon source suitable for use in the process of the present invention is a halocarbon compound. Preferably, the halocarbon compound is a compound represented by the formula CₘXₙ, wherein X is a halogen selected from the group consisting of F, Cl, Br, I, and combinations thereof; m is an integer from 1 to 30; and n is an integer from m to 2m+2.

Preferably, the halocarbon compound is C₁₋₆ haloalkane. Preferably, the halocarbon compound is selected from a group consisting of hexachlorobenzene (C₆Cl₆), hexachlorocyclopentadiene (C₅Cl₆), CF₃CCl₃, CCl₄, and combinations thereof. In a preferred embodiment, C₆Cl₆, C₅Cl₆, CF₃CCl₃ or CCl₄ is employed in the process of the present invention.

Optionally, an additive, e.g. a Fullerene compound, or a porous substrate such as zeolite powder, may be used in the process for the production of the nanocarbon materials according to this invention.

The Fullerene compound suitable for use in the present invention is selected from a group consisting of C₆₀, C₇₀, C₇₈, C₈₀, C₈₂, C₈₄, C₈₆, C₉₀, C₉₂, C₁₀₈, C₁₂₀, and combinations thereof. In a preferred embodiment, the additive employed in the process of the present invention is C₆₀.

Optionally, the metal reducing agent, the carbon source and the additive are mixed concomitantly. In an alternative embodiment, the additive is first mixed with the metal reducing agent, followed by the addition of the carbon source.

For example, when a Fullerene compound is used as the additive, prior to the reaction of the metal reducing agent and the carbon source, the metal reducing agent and the Fullerene compound can be introduced into a reaction container and mixed under ambient temperature and pressure, followed by heating the resultant mixture in vacuo for a period of time, such that the mixture is sublimated and attached onto an inner wall of the reaction container.

Preferably, the Fullerene compound and the metal reducing agent are introduced into the reaction container under ambient temperature and pressure, and the resultant mixture is subjected to a heat treatment at a temperature ranging from 50 to 500° C., preferably from 100 to 400° C., and more preferably from 100 to 200° C., such that the mixture is sublimated and attached onto the inner wall of the reaction container.

Optionally, the Fullerene compound can be concomitantly mixed with the metal reducing agent and the carbon source under an atmosphere of an inert gas.

When a porous substrate is used as the additive, it can be added into the reaction container together with the metal reducing agent and the carbon source to allow the reduction reaction to occur.

In a preferred embodiment according to the present invention, the present invention provides a process for the preparation of nanocarbon materials, comprising the steps of:

(a) introducing a metal reducing agent and a carbon source into a reaction container;

(b) evacuating the container, followed by sealing the container; and

(c) heating the evacuated and sealed reaction container for a sufficient period of time, such that a nanocarbon material product is formed from a chemical reduction reaction of the metal reducing agent and the carbon source.

Preferably, the process further comprises a step of purifying the nanocarbon material product. Specifically, the purifying step is conducted by washing and refluxing the nanocarbon material product with 100° C. deionized water, followed by drying.

Preferably, prior to step (a), the process of the present invention further comprises a preliminary treatment including the steps of:

(1) placing the metal reducing agent and an additive into a reaction container, and

(2) heating the resulting mixture from step (1) for a period of time, such that the mixture is sublimated and attached onto an inner wall of the reaction container.

Preferably, step (1) of the preliminary treatment is conducted under ambient temperature and pressure.

Preferably, step (2) of the preliminary treatment is conducted at a temperature ranging from 50 to 500° C., preferably from 100 to 400° C., and more preferably from 100 to 200° C.

Preferably, the additive used in step (1) of the preliminary treatment is a Fullerene compound selected from a group consisting of C₆₀, C₇₀, C₇₈, C₈₀, C₈₂, C₈₄, C₈₆, C₉₀, C₉₂, C₁₀₈, C₁₂₀, and combinations thereof. More preferably, the additive used in step (1) of the preliminary treatment is C₆₀.

The present invention further provides a nanocarbon material produced by the process described above. Preferably, the nanocarbon material of the present invention can be formed with a structure in the form of nano grahite, carbon onion, or carbon nanotube.

The above and other objects, features and advantages of the present invention will be apparent in the light of the detailed description of the following examples accompanied by the appended Drawings, of which:

### BRIEF DESCRIPTION OF THE DRAWINGS

FIG. 1 is a reaction scheme showing the production of a nano graphite product from a reducing metal Na and a carbon source C₆Cl₆ according to the present invention;

FIG. 2 is a reaction scheme showing the production of a carbon onion product according to the present invention from a reducing metal Na and a five-membered ring compound C₅Cl₆ as the building block molecule;

FIG. 3A is a transmission electron microscope photograph showing the structure of a nano graphite powder produced from Example 1 according to this invention;

FIG. 3B is an enlarged view of a square region taken from FIG. 3A;

FIG. 4 is a transmission electron microscope photograph showing the structure of a carbon onion powder produced from Example 2 according to this invention;

FIG. 5 is a transmission electron microscope photograph showing the structure of a carbon nanotube powder produced from Example 3 according to this invention;

FIG. 6 is a scanning electron microscope photograph showing the structure of a carbon nanotube powder produced from Example 4 according to this invention:

FIG. 7 is a transmission electron microscope photograph showing the structure of a carbon nanotube powder produced from Example 5 according to this invention; and

FIG. 8 is a transmission electron microscope photograph showing the structure of a carbon nanotube powder produced from Example 6 according to this invention.

### DETAILED DESCRIPTIONS OF THE INVENTION

The present invention provides a process for producing a nanocarbon material, which is conducted primarily by subjecting a metal reducing agent and a carbon source, such as a halocarbon compound, to a simple reduction reaction under an atmosphere that will not interfere with the reaction. The process allows the formation of nanocarbon materials in various forms and with a high degree of graphite-like structure. In addition, the by-products generated from the reaction, such as the metal halide salts, can be easily removed.

The process of this invention can be conveniently practiced with the use of simple chemical reaction equipments and under mild reaction conditions. In addition, it is easy to purify the resultant product with a high yield. Therefore, the process of the present invention at least has the following advantages: it is low-energy consuming and cost-efficient in manufacture, it allows the easy purification of products with a high yield, and it is easy to practice using simple chemical reaction equipments.

Although the actual reaction mechanism of the process according to this invention has yet to be known, a possible reaction mechanism may be that when a member of a variety of metals M of different reducing activities is selected and used as a reducing agent, the carbon atoms of the carbon source may be reduced and form linkages therebetween via the Wurtz-type reaction, thereby allowing the formation a variety of nanocarbon materials with a high degree of graphite-like structure. The collaterally formed primary by-products, i e. the metal salts, can be readily separated from the desired nanocarbon materials by washing with a polar solvent.

For example, when a halocarbon compound and a metal M are used as the carbon source and the reducing agent, respectively, via Wurtz-type reaction, the halogen atom X in the halocarbon compound will be converted into an X⁻ ion and leave the carbon atom attached thereto, such that a variety of nanocarbon materials having a high degree of graphite-like structure can be formed from the linking of the reduced carbon atoms. Finally, the collaterally formed primary by-product, i.e. the metal salts M-Xₙ (n is an integer corresponding to the valence of the metal M), can be washed off, e.g. with deionized water.

The halocarbon compound may exist in the form of a polygonal structure (e.g. a five- or six-membered ring), which essentially can serve as a building block molecule of Fullerene compounds and nano graphite products, and examples thereof include C₅Cl₆ and C₆Cl₆, etc. Alternatively, the halocarbon compound may be an alkane molecule commonly employed in the Wurtz-type reaction, such as CCl₄, CF₃CCl₃ and the like.

The operating principle of the process of this invention is illustrated with reference to the following example, in which a nano graphite product is formed from the reduction reaction of a reducing metal M and a building block molecule C₆Cl₆.

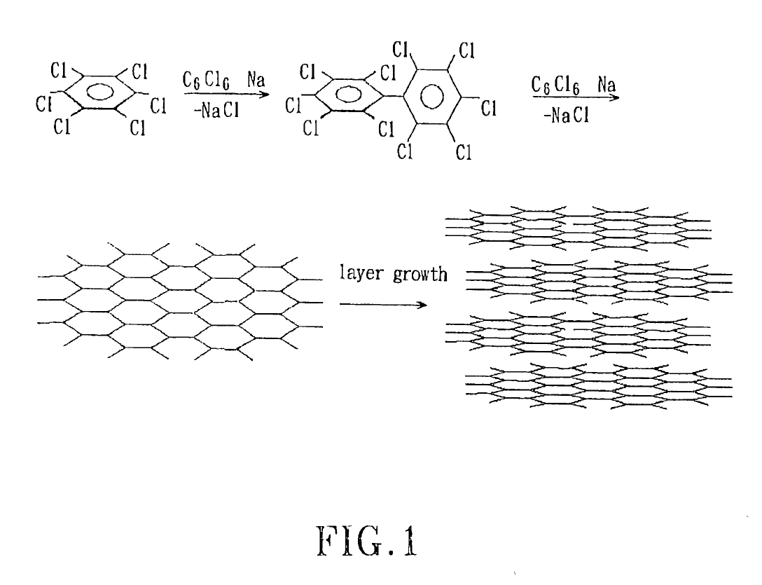

FIG. 1 shows a reaction scheme for the production of a nano graphite product from a reducing metal M and a carbon source C₆Cl₆ according to the present invention. The reaction scheme can be applied to the production of nanocarbon materials from the reactions of other halocarbon compounds with other metal reducing agents.

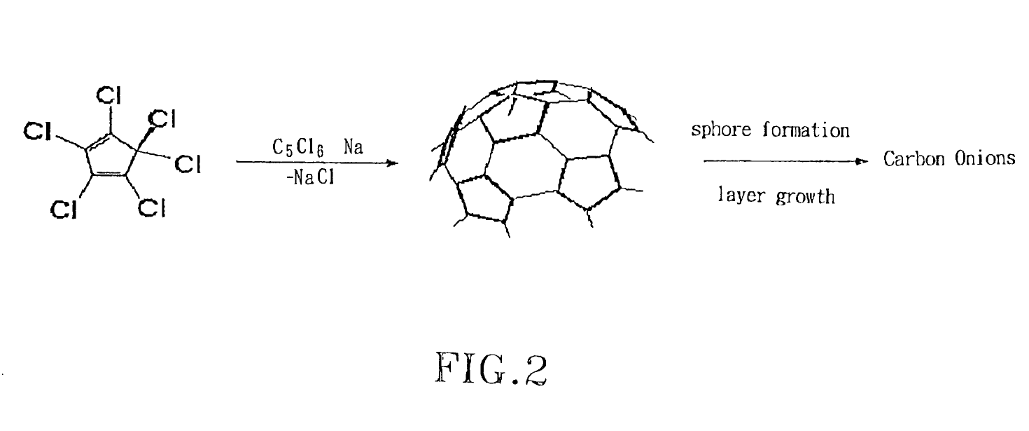

The process of this invention can produce nanocarbon materials in the form of a carbon onion as well For example, referring to FIG. 2, spherical or elliptical carbon onions of various sizes can be produced from the reaction of a reducing metal M (e.g. Na) and a building block molecule of a polygonal structure, such as C₅Cl₆.

Optionally, during the practice of the process of this invention, a small amount of a molecule or a cluster of molecules having a specific structure, such as a Fullerene compound, or a porous substrate such as a zeolite powder, can be added as an additive, such that a high production yield of one-dimensional single-layer or multi-layer carbon nanotubes can be achieved in the absence of any metal catalyst.

Preferably, the Fullerene compound is selected from a group consisting of C₆₀, C₇₀, C₇₈, C₈₀, C₈₂, C₈₄, C₈₆, C₉₀, C₉₂, C₁₀₈, C₁₂₀, and combinations thereof.

When a porous substrate, such as zeolite powder, is used as the additive, it will provide pores of nano meter size for the reducing metal and the carbon source to undergo the Wurtz-type reaction along the porous surface of the porous substrate, and a one-dimensional nanocarbon material product can be likewise formed therefrom.

The following example illustrates the use of a Fullerene compound as an additive in the reaction of a reducing metal M (such as Na) and a carbon source (such as C₆Cl₆), in which C₆₀ is added. Referring to the following reaction equation 1,

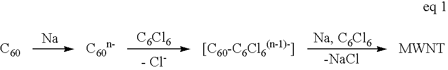

the reducing metal M will firstly reduce the C₆₀ molecule to form a C₆₀ⁿ⁻ ion, which is a strong nucleophilic agent and which may in turn reduce the C₆Cl₆ molecule via the Wurtz-type reaction to result in the linking of the C₆₀ⁿ⁻ ion with the carbon atoms of C₆Cl₆. When the reaction is propagated in the presence of excess amounts of the reducing metal and C₆Cl₆, a multi-layer nanotube (MWNT) product can be formed. Similarly, the above equation 1 can be applied to the production of one-dimensional carbon nanotubes from the reaction of other reducing metals and other halocarbon compounds with the addition of a small amount of a Fullerene compound.

Since the reduction reaction described above is highly exothermic and thermodynamically spontaneous, the process of the present invention can be conducted under a condition using an external energy (e.g. by heating) far lower than that of any known process, to form a variety of nanocarbon materials. Furthermore, the conditions to be used for the production of the desired nanocarbon materials may be adjusted by varying the reducing metal in use, thereby achieving the purpose of controlling the types of products obtained.

According to the process of the present invention, a metal reducing agent and a carbon source are subjected to a chemical reduction reaction under an atmosphere which will not interfere with the reaction, to thereby produce a nanocarbon material.

Concerning the atmosphere which will not interfere with the reaction, it can be provided by subjecting the metal reducing agent and the carbon source to an atmosphere of an inert gas. Preferably, the inert gas is selected from a group consisting of nitrogen gas, helium gas, argon gas, neon gas, krypton gas, xenon gas, and combinations thereof. More preferably, the inert gas is argon gas or nitrogen gas.

Another route to provide the atmosphere which will not interfere with the reaction is by subjecting the metal reducing agent and carbon source to an atmosphere of a reduced pressure. Preferably, the atmosphere of a reduced pressure is provided by introducing a mixture of the metal reducing agent and the carbon source into a reaction container under ambient temperature and pressure, followed by evacuating and sealing the reaction container.

Preferably, the metal reducing agent suitable for use in the process of the present invention includes a metal element selected from a group consisting of group IA metals, group IIA metal, Sn, Ga, In, Pb, Al, Zn, Cu, and combinations thereof. In a preferred embodiment, Na or Sn is employed in the process of this invention as the metal reducing agent.

Preferably, the carbon source suitable for use in the process of the present invention is a halocarbon compound. Preferably, the halocarbon compound is a compound represented by the formula CₘXₙ, wherein X is a halogen selected from the group consisting of F, Cl, Br, I, and combinations thereof; m is an integer from 1 to 30; and n is an integer from m to 2m+2. Preferably, the halocarbon compound is C₁₋₆ haloalkane. Preferably, the halocarbon compound is selected from a group consisting of C₆Cl₆, C₅Cl₆, CF₃CCl₃, CCl₄, and combinations thereof. In a preferred embodiment, C₆Cl₆, C₅Cl₆, CF₃CCl₃ or CCl₄ is employed in the process of this invention as the carbon source.

The present invention will be described in more detail with reference to the following examples, which are given for the purpose of illustration only and are not intended to limit the scope of the present invention.

### EXAMPLE 1

### Production of Nano Graphite Powder

A nano graphite powder product is produced by the following operating procedures in sequence:

(a) placing a mixture of 6 mmol of Na and 1 mmol C₆Cl₆ into a 100 ml glass container under ambient temperature and pressure; or as an alternative procedure, placing 6 mmol Na into the glass container and heating the same under a reduced pressure to result in the sublimation of Na, such that a thin film of Na is formed on the inner wall of the glass container, followed by adding C₆Cl₆ into the glass container;

(b) evacuating the glass container to a pressure of 0.2 torr, followed by sealing the glass container;

(c) heating the sealed glass container to a temperature over 100° C. to allow the reaction of the reactants inside the glass container, such that a black powder product is obtained after a period of 24 hours; and

(d) removing the black powder product from the glass container and filtering, washing and refluxing the same with 200 ml 100° C. deionized water so as to dissolve the by-product NaCl, followed by drying the washed black powder product at 100° C.

As demonstrated by the element analysis and the energy dispersive spectrum (EDS) analysis, the black powder product is composed of carbon. In addition, based on the solid-state ¹³C NMR (nuclear magnetic resonance) analysis, the resonance signals at, 130 and 178 ppm chemical shift positions, which represent the graphite-like (sp²-ordered) and non-graphite-like carbon atoms, respectively, indicate that 70% of the carbon atoms in the black powder product are in crystalline form.

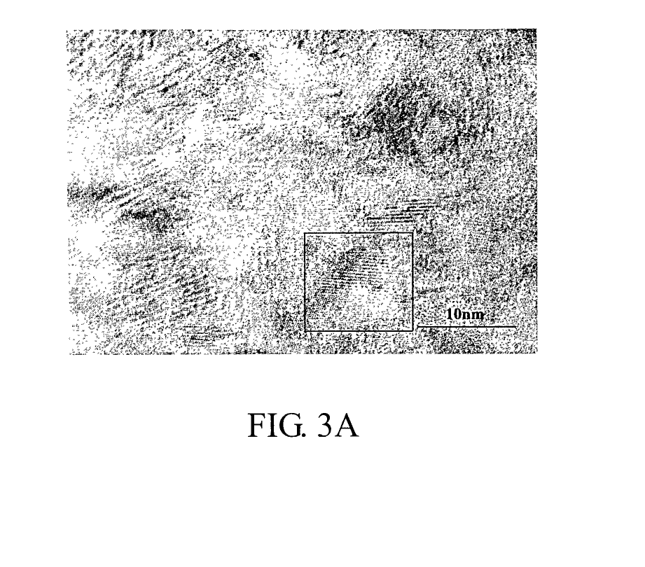

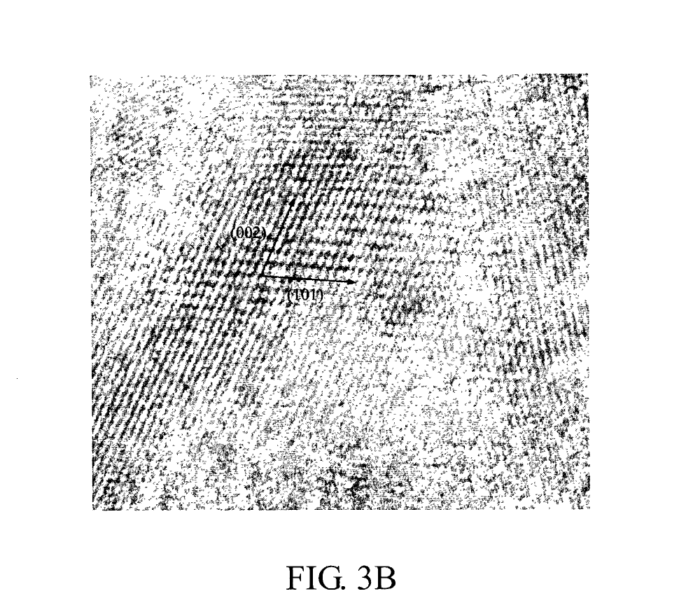

Referring to FIGS. 3A and 3B, the high resolution transmission electron microscopy (HRTEM) image shows that the black powder product is nano graphite. The two arrows shown in FIG. 3B represent the (002) and (101) crystal phases of graphite, respectively.

### EXAMPLE 2

### Production of Carbon Onion Powder

A carbon onion powder product is produced by substantially the same procedures as described in Example 1, except that C₅Cl₆ is used as the carbon source.

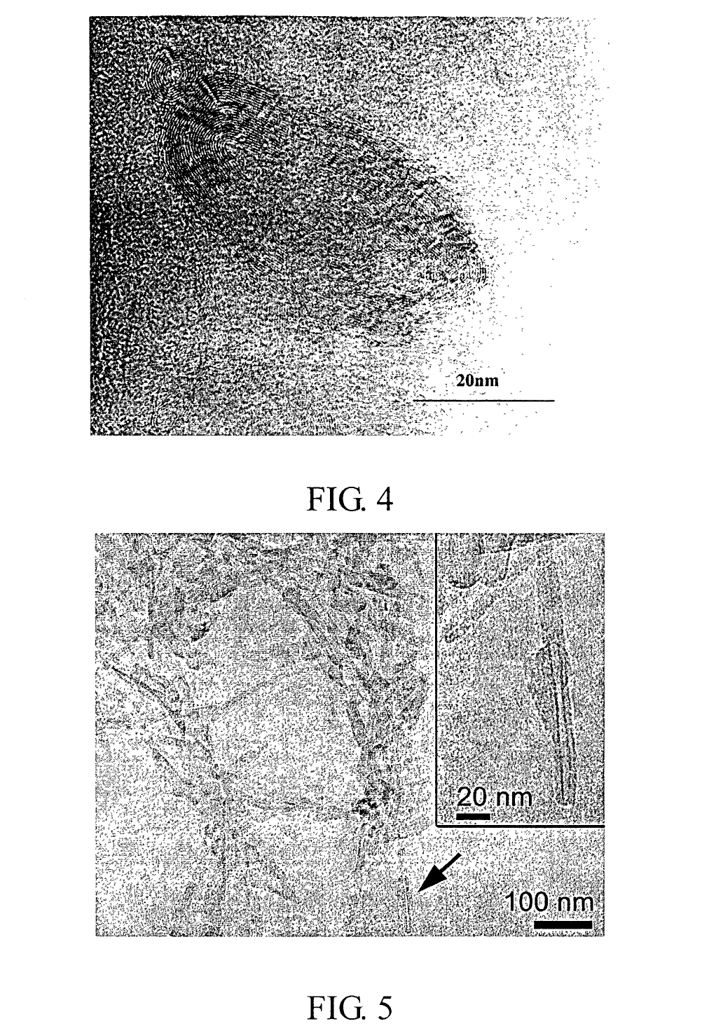

This example also produces a black powder product, 50% of which is in the form of nana graphite, as determined by the ¹³C NMR analysis. Further, referring to the HRTEM image shown in FIG. 4, the black powder product of this example contains various sizes of spherical and elliptical carbon onions, and the number of shells of the carbon onions is in the range of 8 to 50. The smallest onion has 10 shells, and the diameter of the innermost shell is about 2.5 nm. It is observed that the innermost shell is composed of 500-1000 carbon atoms. In addition, the shells of the carbon onions are spaced apart by a distance of about 0.34 nm, which is very close to the layer-to-layer distance present in the graphite structure. Therefore, these carbon onions can be referred to as nano onion graphite.

### EXAMPLE 3

### Production of Carbon Nanotubes

A carbon nanotube product is produced by substantially the same procedures as described in Example 1, except that the following steps are conducted:

(a) placing a mixture of 60.8 mmol of Na and 14 mmol of an additive C₆₀ into the glass container, heating the mixture to a temperature of 300° C. in vacuo, such that the mixture is sublimated to form a thin film on the inner wall of the glass container, followed by adding C₆Cl₆ into the glass container; and

(b) heating the sealed glass container to a temperature of 150° C.

The yield of the resultant black powder product is 97% based on the used amount of C₆Cl₆. Referring to the HRTEM image shown in FIG. 5, the black powder product is primarily composed of multi-layer carbon nanotubes (MWNT). As shown in the image, the carbon nanotube has a 13 layered structure with a diameter of about 12 nm and a layer-to-layer distance of about 0.34 nm, indicating the characteristics of graphite structure. Further, according to the ¹³C NMR analysis of the black powder product, a broad signal appears at the 134 ppm chemical shift position, which is referred to as the characteristic of the sp²-hybridized carbon atoms of the graphite-like structure, and except for this observed signal, the black powder product appears not to have carbon atoms of other configurations. In addition, the Raman spectrum analysis of the black powder product also shows that it has a graphite-like structure.

### EXAMPLE 4

### Production of Carbon Nanotubes

A carbon nanotube product is produced by substantially the same procedures as described in Example 3, except that a small amount of zeolite powder is concomitantly mixed with Na and C₅Cl₆, and the resultant mixture is placed into the glass container, followed by heating the mixture to a temperature of 200° C.

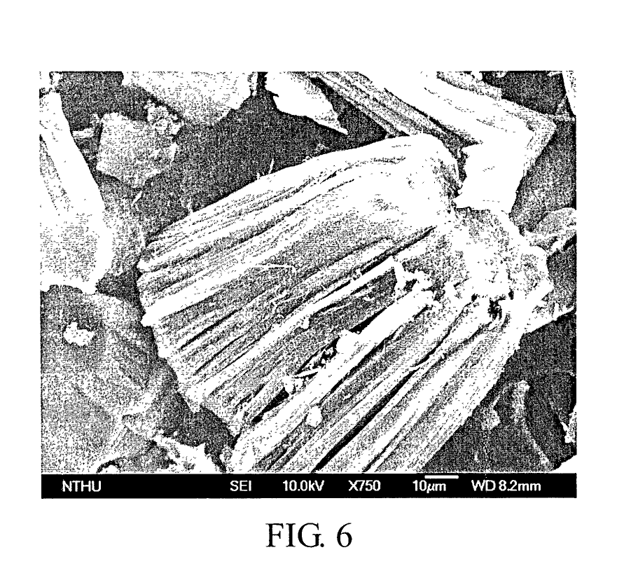

Referring to FIG. 6, the product of this example has a carbon nanotube structure similar to that of the product of Example 3.

### EXAMPLE 5

### Production of Nano Graphite

A nano graphite product is produced by the following operating procedures in sequence:

(a) placing Sn powder into a boat of aluminum oxide, followed by sending said boat to a tubular furnace maintained at a temperature of 300-500° C.; and

(b) delivering a CCl₄ flow into the tubular furnace via an argon gas at a flow rate of 20 ml/min under ambient pressure, such that a chemical reduction reaction between CCl₄ and Sn occurs.

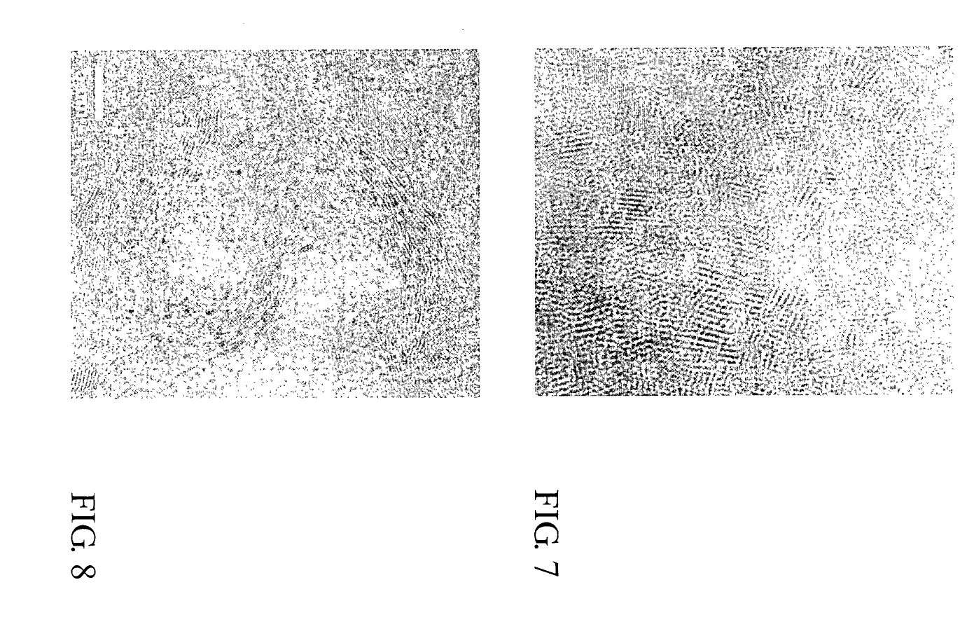

Referring to the HRTEM image shown in FIG. 7, the product of this example is in the form of a nano graphite.

### EXAMPLE 6

### Prodution of Nano Graphite

A nano graphite product is produced by substantially the same procedures as described in Example 1, except that CF₃CCl₃ is used as the carbon source, and the heating treatment of the mixture of Na and CF₃CCl₃ is conducted at a temperature of 200° C. Referring to the HRTEM image shown in FIG. 8, the product of this example is in the form of a nano graphite.

In conclusion, the process for producing a nanocarbon material according to this invention can be practiced with the use of a variety of metal reducing agents and carbon sources, and optionally with the addition of different additives, such that nanocarbon materials of various graphite-like structures can be easily formed via a simple chemical reduction reaction without the need of a heating treatment at a very high temperature. Besides, the process of this invention can produce nanocarbon materials at a higher yield as compared to any known process, whilst having the advantage of easy removal of by-products. Thus, the process of the present invention has the potential for application in large-scale industrial production and is expected to have remarkable industrial values.

While the invention has been described with reference to the above detailed description and the preferred examples, it shall not be construed to be limited thereby. In contrast, it will be apparent to those skilled in the art that numerous modifications and variations can be made without departing from the spirit of the present invention. It is therefore intended that this invention be limited only as indicated by the appended claims.

We claim:

1. A process for producing a nanocarbon material, comprising the step of subjecting a metal reducing agent and a carbon source to a chemical reduction reaction under an atmosphere which will not interfere with the reaction to yield the nanocarbon material.

2. A process according to claim 1, wherein the atmosphere which will not interfere with the reaction is provided by placing the metal reducing agent and the carbon source under an atmosphere of an inert gas.

3. A process according to claim 2, wherein the inert gas is selected from a group consisting of nitrogen gas, helium gas, argon gas, neon gas, krypton gas, xenon gas, and combinations thereof.

4. A process according to claim 3, wherein the inert gas is argon gas.

5. A process according to claim 1, wherein the atmosphere which will not interfere with the reaction is provided by placing the metal reducing agent and the carbon source under an atmosphere of a reduced pressure.

6. A process according to claim 5, wherein the atmosphere of a reduced pressure is provided by placing the metal reducing agent and the carbon source into a reaction container, followed by evacuating and sealing the reaction container.

7. A process according to claim 1, wherein an additive is additionally used in the process.

8. A process according to claim 7, wherein the additive is a Fullerene compound.

9. A process according to claim 8, wherein the Fullerene compound is selected from a group consisting of C₆₀, C₇₀, C₇₈, C₈₀, C₈₂, C₈₄, C₈₆, C₉₀, C₉₂, C₁₀₈, C₁₂₀, and combinations thereof.

10. A process according to claim 9, wherein the additive is C₆₀.

11. A process according to claim 7, wherein the additive is a porous substrate.

12. A process according to claim 11, wherein the porous substrate is zeolite powder.

13. A process according to claim 7, wherein, prior to the reaction of the metal reducing agent and the carbon source, the process further comprises a preliminary treatment including the steps of:
(1) placing the metal reducing agent and the additive into a reaction container;
(2) heating the resultant mixture from step (1) for a period of time, such that the mixture is sublimated and attached onto an inner wall of the reaction container.

14. A process according to claim 13, wherein step (2) of the preliminary treatment is conducted under an atmosphere of a reduced pressure.

15. A process according to claim 13, wherein step (2) of the preliminary treatment is conducted at a temperature ranging from 50 to 500° C.

16. A process according to claim 7, wherein the metal reducing agent, the additive and the carbon source are mixed under an atmosphere of an inert gas.

17. A process according to claim 16, wherein the inert gas is selected from a group consisting of nitrogen gas, helium gas, argon gas, neon gas, krypton gas, xenon gas, and combinations thereof.

18. A process according to claim 1, wherein the process further comprises subjecting the metal reducing agent and the carbon source to a heat treatment.

19. A process according to claim 18, wherein the metal reducing agent and the carbon source are subjected to a heat treatment at a temperature ranging from 50 to 500° C.

20. A process according to claim 19, wherein the metal reducing agent and the carbon source are subjected to a heat treatment at a temperature ranging from 100 to 400° C.

21. A process according to claim 19, wherein the metal reducing agent and the carbon source are subjected to a heat treatment at a temperature ranging from 300 and 500° C.

22. A process according to claim 19, wherein the process further comprises a step of purifying the resultant nanocarbon material product.

23. A process according to claim 22, wherein the purifying step is conducted by washing and refluxing the nanocarbon material with 100° C. deionized water, followed by drying.

24. A process according to claim 1, wherein the carbon source is a halocarbon compound.

25. A process according to claim 1, wherein the halocarbon compound is a compound represented by the formula CₘXₙ, wherein X is a halogen selected from a group consisting of F, Cl, Br, I, and combinations thereof; m is an integer from 1 to 30; and n is an integer from m to 2m+2.

26. A process according to claim 25, wherein the halocarbon compound is C₁₋₆ haloalkane.

27. A process according to claim 25, wherein the halocarbon compound is selected from a group consisting of C₆Cl_{6,} C₅Cl₆, CF₃CCl₃, CCl₄, and combinations thereof.

28. A process according to claim 27, wherein the halocarbon compound is C₆Cl₆.

29. A process according to claim 27, wherein the halocarbon compound is C₅Cl₆.

30. A process according to claim 27, wherein the halocarbon compound is CCl₄.

31. A process according to claim 27, wherein the halocarbon compound is CF₃CCl₃.

32. A process according to claim 1, wherein the metal reducing agent includes a metal element selected from a group consisting of group IA metals, group IIA metals, Sn, Ga, In, Pb, Al, Zn, Cu, and combinations thereof.

33. A process according to claim 32, wherein the metal reducing agent is Na.

34. A process according to claim 32, wherein the metal reducing agent is Sn.

35. A nanocarbon material produced by a process according to claim 1.

36. The nanocarbon material according to claim 35 having a structure in the form of nano graphite.

37. The nanocarbon material according to claim 35 having a structure in the form of carbon onions.

38. The nanocarbon material according to claim 35 having a structure in the form of carbon nanotubes.

39. A process for producing a nanocarbon material comprising the steps of
(a) introducing a metal reducing agent and a carbon source into a, reaction container;
(b) evacuating the reaction container, followed by sealing the reaction container and
(c) heating the evacuated and sealed reaction container for a sufficient period of time, such that a nanocarbon material product is formed from a chemical reduction reaction of the metal reducing agent and the carbon source.

40. A process according to claim 39, wherein the carbon source used in step (a) is a halocarbon compound.

41. A process according to claim 40, wherein the halocarbon compound is a compound of formula CₘXₙ, wherein X is a halogen selected from a group consisting of F, Cl, Br, I, and combinations thereof; m is an integer from 1 to 30; and n is an integer from m to 2m+2.

42. A process according to claim 41, wherein the halocarbon compound is a C₁₋₆ haloalkane

43. A process according to claim 41, wherein the halocarbon compound is selected from a group consisting of C₆Cl₆, C₅Cl₆, CF₃CCl₃, CCl₄, and combinations thereof.

44. A process according to claim 43, wherein the halocarbon compound is C₆Cl₆.

45. A process according to claim 43, wherein the halocarbon compound is C₅Cl₆.

46. A process according to claim 43, wherein the halocarbon compound is CF₃CCl₃.

47. A process according to claim 40, wherein in step (a), a mixture of the metal reducing agent and the halocarbon compound is introduced into the reaction container under ambient pressure and temperature.

48. A process according to claim 39, wherein the metal reducing agent used in step (a) is selected from a group consisting of group IA metals, group IIA metals, Sn, Ga, In, Pb, Al, Zn, Cu, and combinations thereof.

49. A process according to claim 48, wherein the metal reducing agent is Na.

50. A process according to claim 48, wherein the metal reducing agent is Sn.

51. A process according to claim 39, wherein step (c) is conducted at a temperature ranging from 50 to 500° C.

52. A process according to claim 39, further comprising a step of purifying the nanocarbon material product from step (c).

53. A process according to claim 52, wherein the purifying step of is conducted by washing and refluxing the nanocarbon material product with 100° C. deionized water, followed by drying.

54. A process according to claim 39, wherein, prior to step (a), the process comprises a preliminary treatment including the steps of:
(1) placing the metal reducing agent and an additive into a reaction container;
(2) heating the resultant mixture from step (1) for a period of time, such that the mixture is sublimated and attached onto an inner wall of the reaction container.

55. A process according to claim 54, wherein step (1) of the preliminary treatment is conducted under ambient temperature and pressure.

56. A process according to claim 54, wherein step (2) of the preliminary treatment is conducted under an atmosphere of a reduced pressure.

57. A process according to claim 54, wherein step (2) of the preliminary treatment is conducted at a temperature ranging from 50 to 500° C.

58. A process according to claim 54, wherein the additive used in step (1) of the preliminary treatment is a Fullerene compound selected from a group consisting of C₆₀, C₇₀, C₇₈, C₈₀, C₈₂, C₈₄, C₈₆, C₉₀, C₉₂, C₁₀₈ , C₁₂₀ and the combinations thereof.

59. A process according to claim 58, wherein the additive is C₆₀.

60. A process according to claim 39, wherein in step (a), an additional porous substrate is added into the reaction container.

61. A process according to claim 60, wherein the porous substrate is zeolite powder.

62. A nanocarbon material produced by a process according to claim 39.

63. The nanocarbon material according to claim 62 having a structure in the form of nano graphite.

64. The nanocarbon material according to claim 62 having a structure in the form of carbon onions.

65. The nanocarbon material according to claim 62 having a structure in the form of carbon nanotube.
